(19) United States
(12) Patent Application Publication
(10) Pub. No.: US 2011/0087859 A1
(43) Pub. Date: Apr. 14, 2011

(54) SYSTEM CYCLE LOADING AND STORING OF MISALIGNED VECTOR ELEMENTS IN A SIMD PROCESSOR

(76) Inventor: Tibet Mimar, Sunnyvale, CA (US)

(21) Appl. No.: 10/357,640

(22) Filed: Feb. 3, 2003

Related U.S. Application Data
(60) Provisional application No. 60/354,336, filed on Feb. 4, 2002.
(60) Provisional application No. 60/364,315, filed on Mar. 14, 2002.

(51) Int. Cl. G06F 15/76; G06F 9/02; G06F 9/30

(52) U.S. Cl. 712/4; 712/41; 712/E09.002; 712/E09.016

(57) ABSTRACT

The present invention provides efficient transfer of misaligned vector elements between a vector register file and data memory in a single clock cycle. One vector register of N elements can be loaded from memory with any memory element address alignment during a single clock cycle of the processor. Also, a partial segment of vector register elements can be loaded into a vector register in a single clock cycle with any element alignment from data memory. The present invention comprises properly partitioned multiple multi-port data memory modules in conjunction with a crossbar and address generation circuit. A preferred embodiment of the present invention uses a dual-issue processor containing both a RISC-type scalar processor and a vector/SIMD processor, whereby one scalar and one SIMD instruction are executed every clock cycle, and the RISC processor handles program flow control and also loading and storing of vector registers.

### BACKGROUND OF THE INVENTION

1. Field of the Invention

The invention relates generally to the field of processor chips and specifically to the field of single-instruction multiple-data (SIMD) processors. More particularly, the present invention relates to loading vector registers in a SIMD processor.

2. Description of the Background Art

In a processor that features a N-byte wide processing, the data memory also has this width to support the processor execution unit. For example, a 32-bit RISC processor has a 32-bit wide data memory. The data memory is usually addressed in byte addresses, i.e., an address signifies the byte address. If a 32-bit load is attempted from an address that is not aligned to a 32-bit boundary, i.e., where the least significant two address bits are not zero, then such a request takes two load instructions, because two different locations of data memory has to be accessed: the one at the effective address and the remainder from the next location of memory. Note that data memory addresses in this example are address bits 2 and higher, and address bits 0 and 1 determine one of the four bytes within the 32-bit entry of a memory address. MIPS handles such misaligned loads by using two instructions LOADL (load left) and LOADR (load right) when an address may not be aligned.

The alignment becomes a bigger issue for loading of vectors in a SIMD processor. The data memory in this case is N elements wide, and boundary lines for alignment correspond to the addresses that match the width of the data memory. For example, for the preferred embodiment with 16 elements where each element is 16-bits, the boundaries are modulo 32 in byte addresses. If we load a 16 element vector where address is 0, 32, 64, k*32, then loading of vector is aligned and this means we could read all 16 elements from a given location of N element wide memory. In vector loads, the load address corresponds to the address in bytes pointing to first vector element of the plurality of consecutive vector elements stored in data memory. If a vector transfer operation is not aligned to data memory width, k*32 in this case, then that location and the following location has to be accessed to read the whole vector which crosses the modulo-N boundary. The first line pointed by address is hereinafter referred to as “Line” or “Current Line” which contains some or all of the vector elements, and following line that contains the rest of the vector elements for misaligned transfers is hereinafter referred to as “Line+1” or “Next Line”, as shown in FIG. 1, which shows a SIMD processor with 8 elements and example of loading an 8-element vector from a data memory that is 8 elements wide. If the starting address from which the vector to be loaded points to 5^{th} element of the data memory, then such a vector load requires two instructions, load-vector which loads the elements from the first line of data memory pointed by vector address, and load-vector-remainder instruction which loads the remainder from the next address of data memory. In this case, the vector load instruction LDV VR1, 0(R0) loads vector of 8 vector elements pointed to by a scalar register R0 and zero offset to vector register VR1. LDR loads the remainder 5 vector elements from line-plus-one address. Here we assume the data memory width is the same as the width of vector registers so that an aligned vector load or store operation can be performed in one clock cycle.

We cannot restrict accesses to always-aligned accesses, because popular applications like FIR implementation in a SIMD processor requires loading of vectors from successive element locations. This means that, if the first one is aligned then the following N-1 loads will not be aligned. This means for each access after the first one which is known to be aligned, we have to perform two vector read operations: load vector and load-remainder-vector. We will hereinafter refer to such vector transfer operations that are not aligned to data memory boundaries as “misaligned vector transfers”.

Motorola's AltiVec chip requires a vector-shift load left or right and vector-permute instructions to load from unaligned addresses. This requires two or three instructions to load an unaligned vector.

Loading from data memory with any alignment is a requirement for proper SIMD operation. Since a program cannot always know if the address is vector aligned or not, we can always perform load-vector followed by load-vector-remainder.

Some processors (VICE) have dual issue where one scalar instruction and one vector instruction is executed every clock cycle. The scalar instruction handles loading and storing of vector registers, and if a load/store operation could be done in one clock cycle, any overhead for vector register load/store could be done in parallel with vector processing operations. However, when a load or store takes two or three clock cycles, then the vector-processing unit has to stay idle during these additional cycles, which reduces the processing efficiency of hardware.

Furthermore, some operations such a FIR filters with long filter kernels require two load operations, one for kernel, one for data, and again this causes the vector-processing unit to idle during these additional cycles. For example, if the kernel has 256 values and there are only 32 vector registers with 8 elements each, we have to load both the kernel and data values continuously, but this reduces the processing power to one-half because vector registers cannot be loaded as fast as the processing unit could process them. In this case, the ability to load multiple vector registers in a single clock cycle is important. The number of load instructions for each processing instruction would be four for VICE and AltiVec processors. Such “starving” for input data significantly reduces the computational throughput of SIMD.

Ito et al proposed an approach to check the overlap current read compared to a previous vector read operation, and if there is partial overlap of vector elements to read these from a previously saved vector register file, where such vector element cache operation is performed without doing a second remainder load operation and is done automatically by the hardware logic. However, Ito's approach requires that accesses are performed to consecutive locations (in an address post increment or predecrement mode of addressing) and there be an overlap of vector elements in such consecutive. Otherwise, two independent vector reads from two different misaligned vector addresses with no overlap of vector elements still requires two clock cycles for each such access. Also, Ito's approach still requires two clock cycles for the initial access where part of the vector is not in the local cache of one or two previous accesses. Ito's approach could be successfully used for implementation of one-dimensional FIR filters, however, in this case the very first access will still require two clock cycles, but this is a small overhead if the filter kernel size is size. Ito in this case, can have two registers internally for pointing to data and kernel values, so that both data vector and kernel values could be read with a single clock cycle after the first one.

There are many other applications for which we cannot ensure that vector load or write operations are not always aligned. For example, a lot of video processing applications involve two-dimensional operations such as convolution by a 5×5 kernel (2-dimensional FIR), as shown in FIG. 10. This requires “sliding” a window of 5×5 filter kernel values over video pixel values, and for each position multiply-accumulate of video pixel values and corresponding 5×5 filter kernel values generates a single output value. Such an operation is sometimes further complicated by sometimes in-place operation of red-green-blue-alpha (RGBA) values, where each position of pixel has four such values. In such a case, even if pointer to first line of 2-D area is aligned, it is likely that pointer to next line is not aligned to vector boundaries, because line size which represents the “stride” value of address increment between X and X+Line Size is not necessarily a multiple of data memory width.

One of the most commonly used application of MPEG-2, MPEG-4 is motion compensation in a video decoder which is embedded in all DTV, DVD and Bluray players, and set top boxes, is decoding of blocks in a B frame, which represents the highest compression efficiency. The encoder sends an x and y-offset which corresponds to movement of such a block instead of sending the block of 16×16 values. This requires reading a block a specified frame memory address and moving it to the current block address with or without subpixel interpolations, as shown in FIG. 11. In such a case, there is no guarantee of vector alignment. This means reading block of 16×16 block will require 2*16, or 32 clock cycles, instead of 16 it they were aligned or if misaligned vectors could be read in one clock cycle. This doubles the motion compensation time for decoder.

There are numerous other applications of vector processing which require access to misaligned vector for efficient operation. An example of such a commonly used such application is deblocking filter used in MPEG-4.10 standard. A conditional filtering process is specified that is an integral part of the decoding process which shall be applied by decoders conforming to the Baseline, Extended, Main, High, High 10, High 4:2:2, and High 4:4:4 Predictive profiles. The conditional filtering process is applied to all N×N (where N=4 or N=8 for luma, N=4 for chroma when Chroma Array Type is equal to 1 or 2, and N=4 or N=8 for chroma when Chroma Array Type is equal to 3) block edges of a picture, except edges at the boundary of the picture and any edges for which the deblocking filter process is disabled by disable-deblocking-filter-parameter. This filtering process is performed on a macroblock basis after the completion of the picture construction process prior to deblocking filter process. The deblocking filtering process applies a 8-tap filter kernel to vertical edges of a 16×16 macroblock, as shown in FIG. 12. This vertical filter kernel is “slided” vertically and deblocked filter output is calculated. Assuming the vertical edges of macroblock is placed such that it aligns with 16-element wide data memory of preferred embodiment, we still have 4 out of 4 vertical edges that require misaligned access to vector reads. This is because, even the first vertical boundary requires read of a vector starting 4 locations before the boundary in placing the 8-tap filter over the vertical boundary. This would require additional 4 times 16 transfers, or 64 additional vector reads per each macroblock, if misaligned transfers require two instead of one clock cycles.

Requiring multiple load instructions to load elements of a vector register from an unaligned data memory address significantly reduces the processing power of a SIMD that could be sustained. This is because plurality of multipliers and other data processing hardware remain idle during load operations; hence they are well utilized. This is also true for dual-issue processors, which support executing one scalar instruction and one vector instruction every clock cycle.

### SUMMARY OF THE INVENTION

The present invention provides loading and storing of vector registers with any element alignment between local data memory and vector register file in a single clock cycle. The present invention uses data memory that is partitioned into N modules or even and odd lines stored in two different memory banks, where each module may be dual-ported. Depending on the access address, the specified address or its incremented value is selected for each of the memory modules. Crossbar reorders these values from each of the plurality of at least two memory modules for a particular alignment.

### BRIEF DESCRIPTION OF THE DRAWINGS

The accompanying drawings, which are incorporated and form a part of this specification, illustrated prior art and embodiments of the invention, and together with the description, serve to explain the principles of the invention.

Prior Art FIG. 1 shows an exemplary misaligned vector load by SGI's VICE SIMD processor.

FIG. 2 shows block diagram of one embodiment of present invention.

FIG. 3 shows details of crossbar logic circuit and control of this crossbar circuit.

FIG. 4 shows details of how address select circuit and data output crossbar is controlled as a function of address bit-field that is low-order address bits of pointer to first vector element in data memory.

FIG. 5 shows example of aligned vector read/write operation.

FIG. 6 shows example of misaligned vector read/write operation.

FIG. 7 shows another example of misaligned vector read/write operation.

FIG. 8 shows a second embodiment of present invention using data memory partitioned as memory containing even lines of data, and memory containing odd lines of data.

FIG. 9 shows details of actual data ports of data memory and select logic consisting of separate read and write ports and different select logic for each direction of data transfer.

FIG. 10 illustrates a 2-dimensional 5×5 window of operation within a two-dimensional video data.

FIG. 11 illustrates a 16×16 block, the position of which within a two-dimensional video data is determined by MPEG decoder.

FIG. 12 shows an example case of deblocking application of MPEG-4.10 compression standard requiring block edge filtering where misaligned vector transfer operations are required.

FIG. 13 shows another embodiment showing tightly coupled RISC and SIMD processor.

FIG. 14 shows another embodiment with a DMA engine coupled to a second data port of data memory banks.

### DETAILED DESCRIPTION

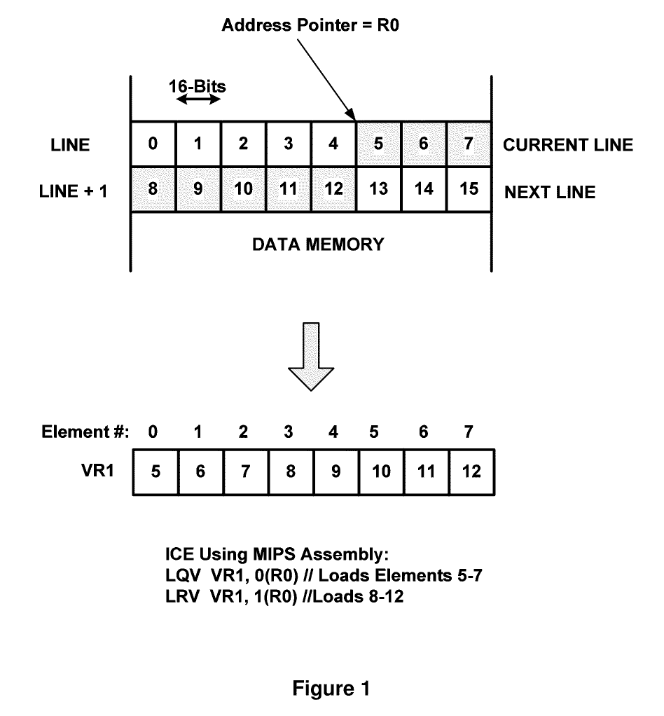

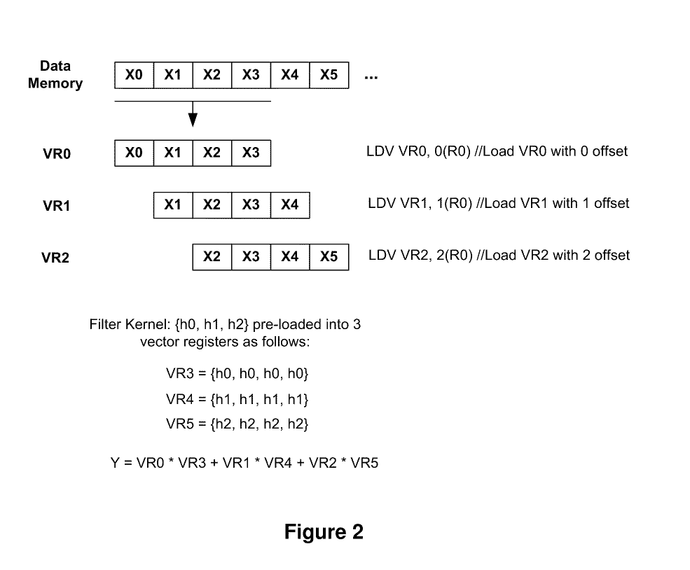

For accessing a vector an address is formed from an address pointer scalar register R0 plus any offset. The address pointing to beginning of vector to be transferred is R0 plus constant offset value. The present invention in one embodiment uses N memory modules for a N-wide SIMD processor, where each memory module has the width of a vector element, as shown in FIG. 2. This figure shows the preferred embodiment for 16 element SIMD memory. Address input (ADDR) port of each memory module is connected selectors SEL0 to SEL15220.One of the inputs of these select one-of-two input logic is connected to address bit-field Addr [M:5] which refers to the address bits 5 and above of R0 plus any constant offset value. The highest bit number M is determined by the size of each memory module. If each memory module is 64K entries, then M is 16. Each entry is 16-bits and occupies 2 byte addresses and all addresses are calculated in terms of bytes, even though minimum addressable unit for this embodiment is 16-bits. These address bits determine which entry line of memory being accessed by the vector load or vector store instruction. The lower address bit-field of Addr [4:1] determine the beginning of vector transfer by pointing to the first vector element address to be transferred. The incrementer 310 takes the address bit-field bits M through 5, inclusive, and increments it by one to point to the next line or next entry of address for each partitioned memory module These address₁₃selectors 220 choose the line address or line-plus-one for each memory module. Depending on address bits 1 through 4 we know how the wrapping of memory locations will occur. The address bit 0 does not become part of this, because the minimum accessible unit is two bytes or 16-bits. If the vector address is misaligned to the width of the data memory, there will be a wrap around to the next line. Based on a given address, the address bits [4:1] connected to address logic 200 determines how this wrap around occurs. If all of the address bits [4:1] are zero, then the access, vector read or write, is an aligned access with no wraparound. If address bits [4:1] are not all zeros, then ADDR Logic 200 determines whether line address (Addr[M:5]), or next line address (Addr[M:5]+1) is selected for each of the memory modules. Thus, units of address logic (ADDR Logic) 200, incrementer 210, and address select logic 220 constitute a means for address generation for memory that is partitioned into N modules.

For non-aligned accesses the output of N memory modules has to be re-ordered, which is performed by the crossbar logic 250. The crossbar logic is connected to vector register file and outputs a read vector, or takes a vector to write to data memories. Vector register file is connected to vector execution unit for processing SIMD vector instructions. Thus, unit 270 constitute means for vector processing for execution of vector instructions such as vector-add and vector-multiply, and vector multiply-accumulate instructions.

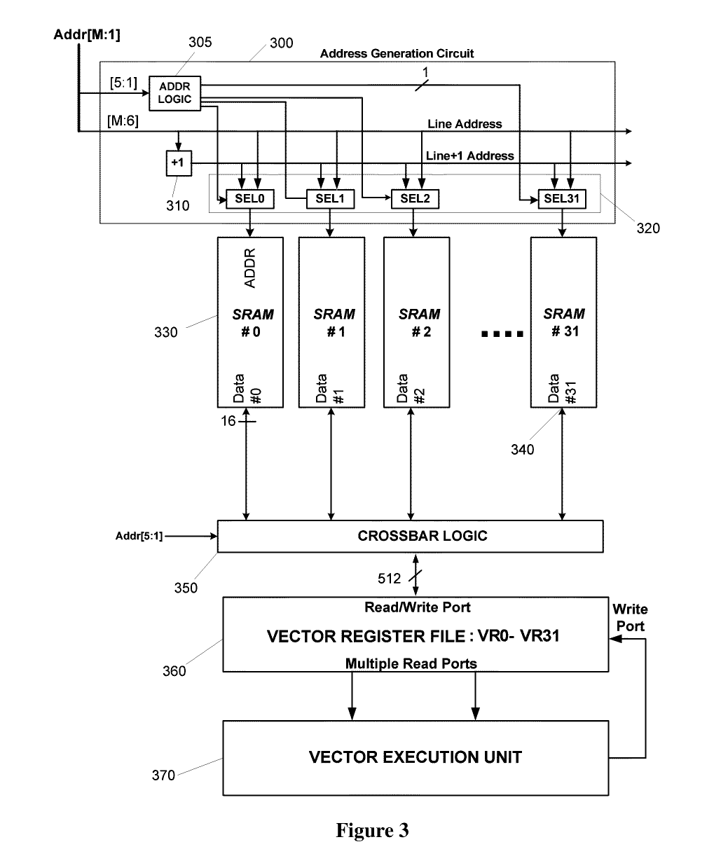

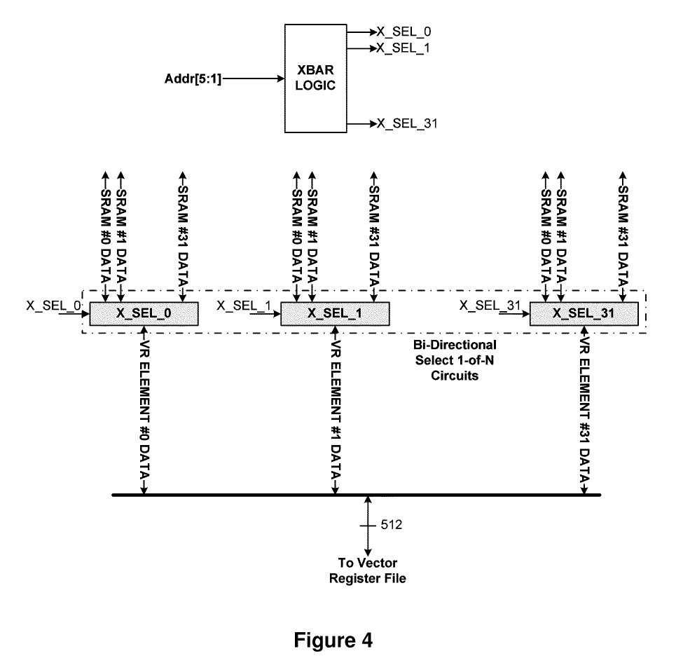

FIG. 3 shows the details of the crossbar logic 250. As a function of address bits [4:1], one of the data memory modules is mapped for each vector element position based on the mapping defined in FIG. 4. Thus, crossbar unit of 250 constitute means mapping logic for reordering vector elements during transfers of said plurality of vector elements between said vector register file and said data memory in accordance with address bits 4:1. For example, if the address bit-field of 4:1 is 2, then for a vector load operation vector register elements numbered 0 through N are mapped from outputs of SRAM modules numbered {2, 3, 4, 5, 6, 7, 8, 9, 10, 11, 12, 13, 14, 15, 0, 1}.

FIG. 4 shows the fix function of both address select control for select logic 220 and crossbar 250 for all possible cases of alignment. For example, if Address bits [4:1] equal to 1, then Line address input is selected for memory modules 1 through 15, and Line+1 address input is selected for memory module 0. The first vector element is read from memory module #1, thus it is routed back to vector zero position by the crossbar, the output of memory module #0 is routed to vector element position #15 by the crossbar circuit.

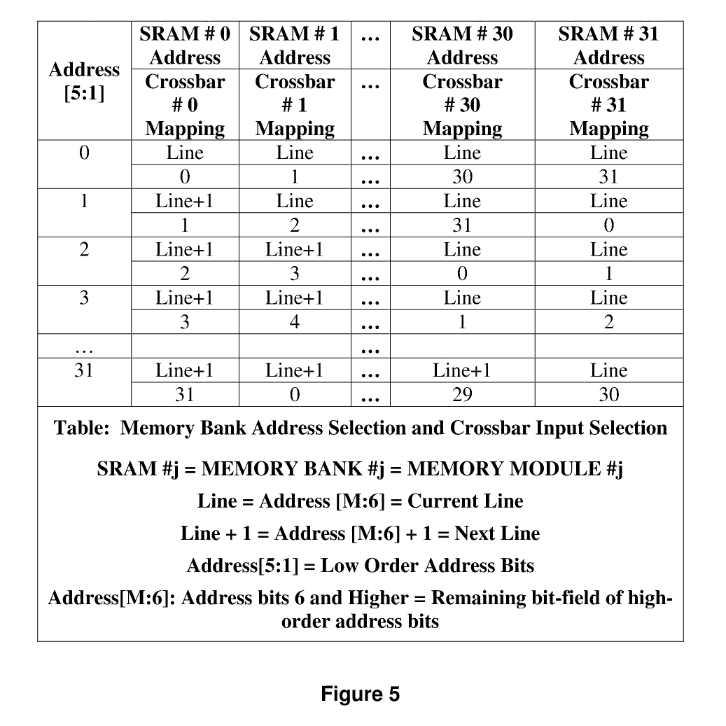

FIG. 5 shows an example of aligned vector read or write operation. In this case, low-order address bits Addr[4:1] are all zeros, and all vector elements are read from Line address, and no mapping of vector elements is necessary by the crossbar logic, which passes vector elements without any mapping of their vector element positions. The selected address for memory module are all Line addresses.

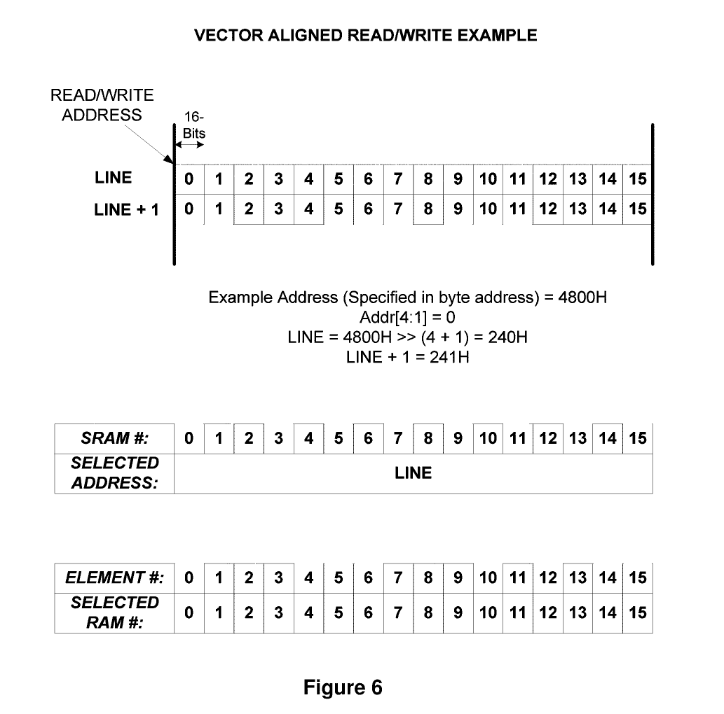

FIG. 6 illustrates the example where the read or write address points to second vector element position address. In this case, for the first memory module Line+1 address is selected by SEL0, and for the rest, SEL1-15, Line address is selected as shown at 600. Crossbar maps memory module output #1 to 0, #2 to 1, and so forth, and vector position #15 is mapped from memory module #0 as shown at 810.

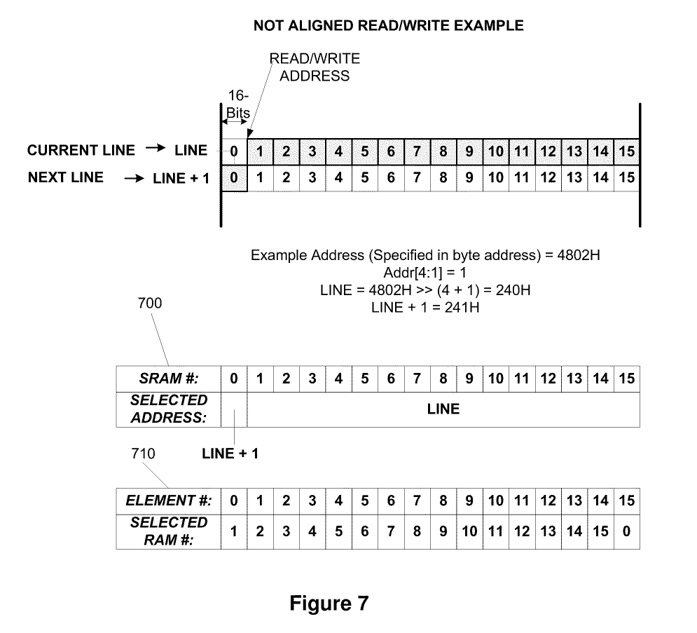

FIG. 7 illustrates the example where the first element position is read from the end of the line and the rest of the vector is wrapped to second line. In this case, all address select logic SELO-14 chooses Line+1, and SEL15 chooses Line. The crossbar performs mapping such that vector element position #0 is mapped from memory module #15, element position #1 is mapped from memory module #0, element position #2 is mapped from memory module #1, and so forth.

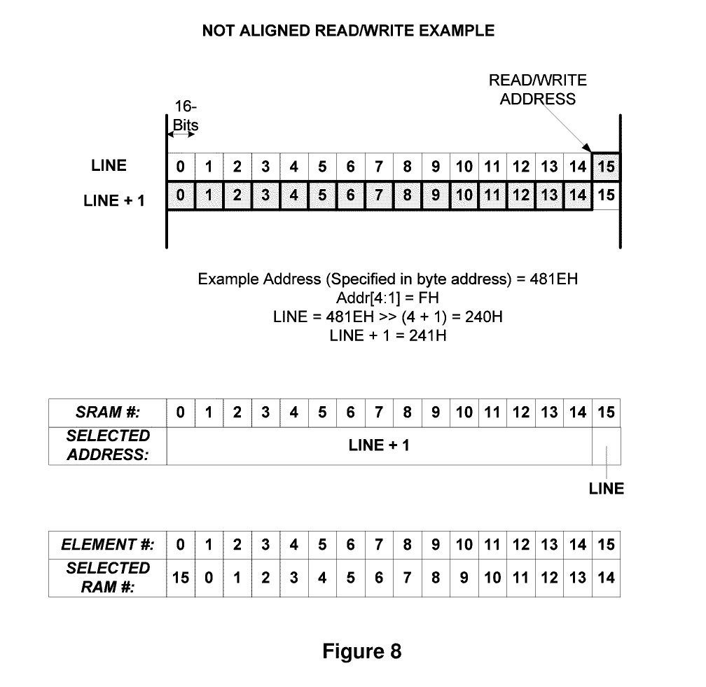

Second embodiment of present invention uses dual memory banks as even line memory 800 that contains even lines and odd line memory 810 that contains odd lines available in parallel, as shown in FIG. 8. Address bits M:6 are connected to odd line memory bank. If address points to even line memory (Address bit 5=0) as the starting address of vector, then even memory corresponds to line and odd line corresponds to line-plus-one. Selecting address bits Addr[M:6] for odd memory bank and incrementing Addr[M:6] by Addr[5] constitute a means for address generation for even and odd memory banks. If address points to odd line of memory as the starting of vector to be transferred than the following even line address is calculated by adding 1 to address [M:6]. The select logic 220 is the same of first embodiment. Address selection of first embodiment is replaced by data select logic 820, which functions similarly to ADDR Logic of first embodiment, except selection for each vector element position is inverted of even line addressed is after the odd line, i.e., when address bit 5 is one. The crossbar operation is the same as the first embodiment.

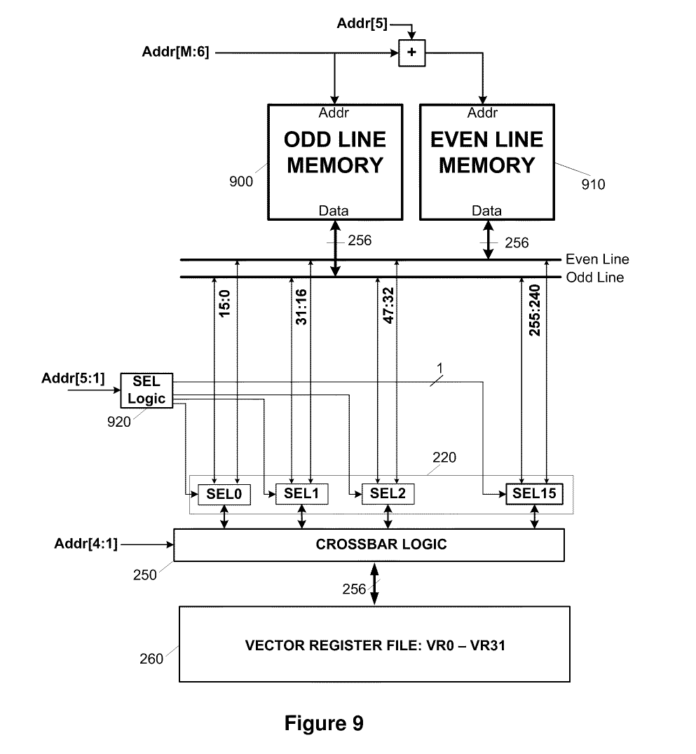

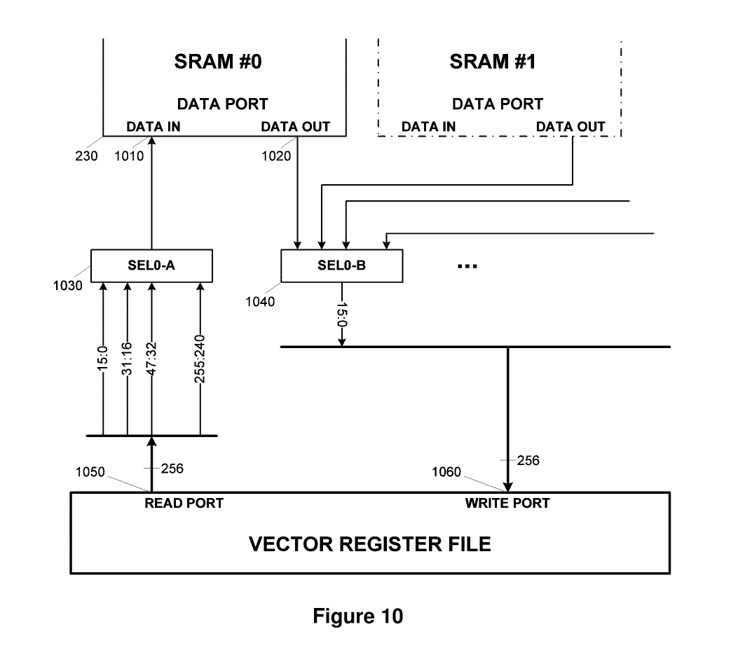

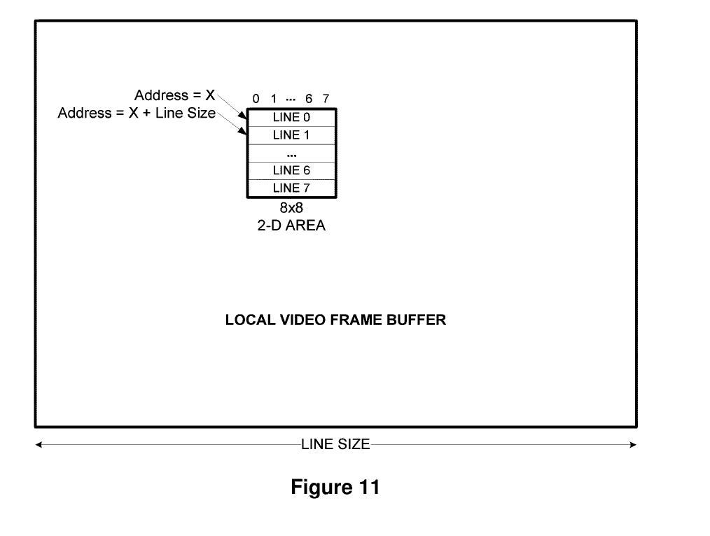

The select logic shown in the two embodiments above as a bidirectional unit, but in actual circuit there is one set of select logic in the read direction connected, and different set of select logic for the write direction. Similarly, a data port of a memory module shown above actually consists of a data-out port and a data-in port. For the vector register file, there are separate vector read and write data ports. This is illustrated in FIG. 9, which shows for the vector load (vector load from data memory to a vector register), there is a select logic SELO-B at 940 that chooses one of the 16 data-out ports of 16 data memory modules for first vector element position indicated by 15:0. Similarly, there is a separate select logic SEL1-15B for selecting the rest of the vector elements for the vector load operation. The output of these 16 16-to-1 select logics are coupled to a write port 960 of the vector register file.

Similarly, for a vector write operation (write from a vector register to data memory), vector data is read from a read port 950 as 256-bits wide, and is partitioned into 16 vector elements, each 16 bits. These 16 vector element values are coupled to 16-by-1 select logic SELO-A 930, which outputs a selected vector element that is connected to data in port of SRAM #0 910, and so forth for the other SRAM data memory modules.

Also, both first and second embodiments use a write enable logic for memory banks that enables write operations that corresponds to vector elements to be written for vector store operations.

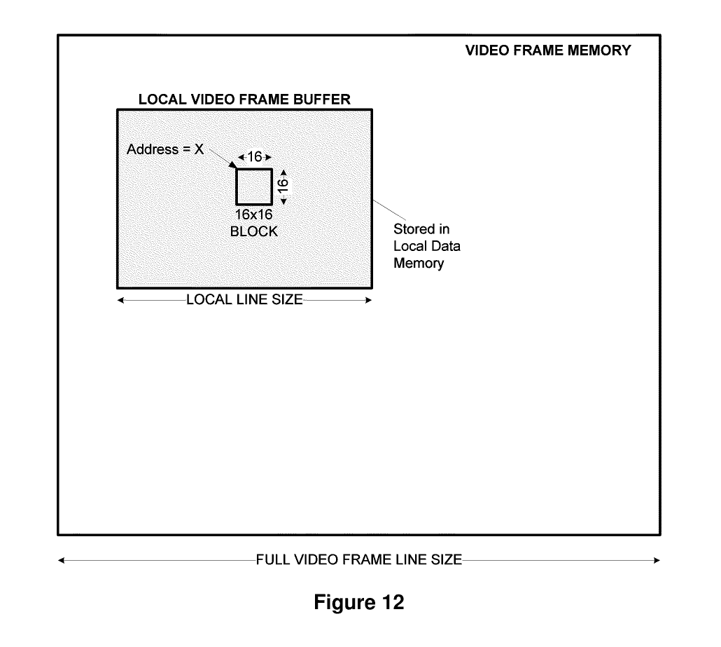

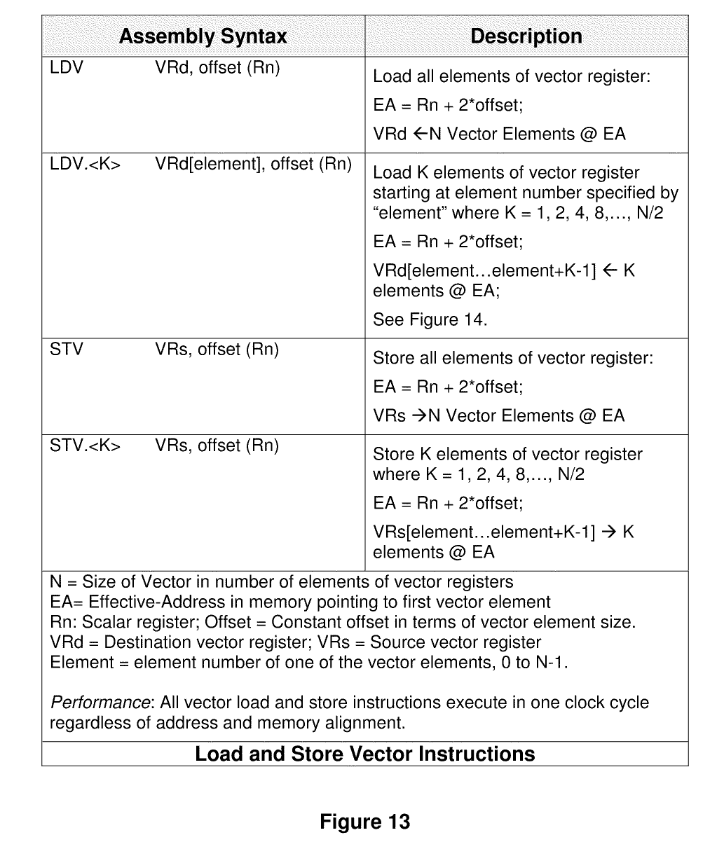

If the SIMD processor handles both vector operations and vector load/stores, this means the vector execution circuit stays idle during vector load/store operations. FIG. 12 shows an embodiment which could be combined with first or second embodiment, wherein a RISC processor handles all program flow and vector and scalar load and store operations, and SIMD processor performs data processing. This means such a tightly coupled processor is capable of executing two instructions for each clock cycle: One RISC instruction and one SIMD instruction. RISC could perform vector load/store operations and SIMD performs vector data processing.

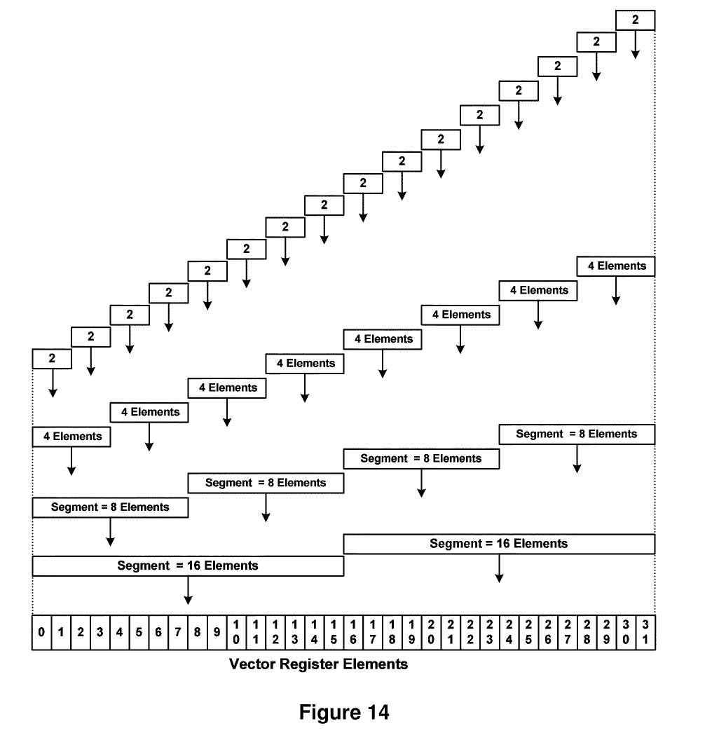

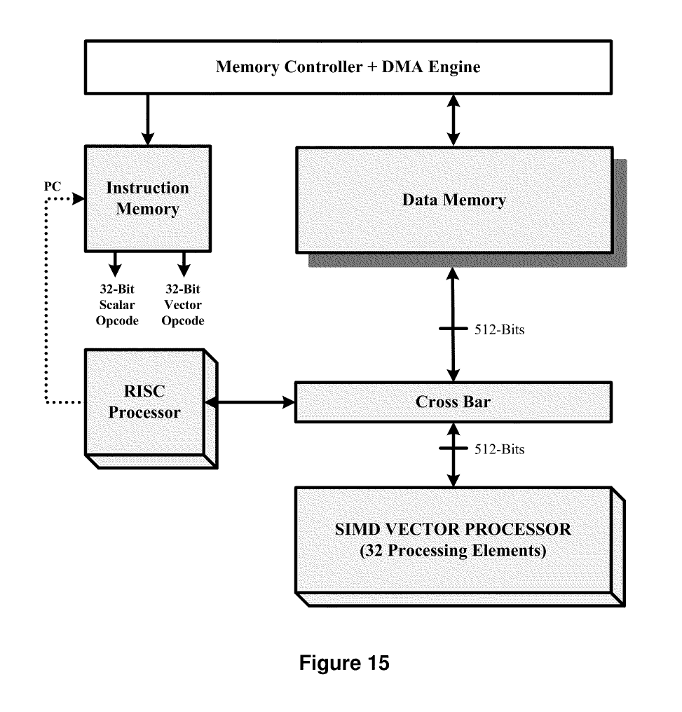

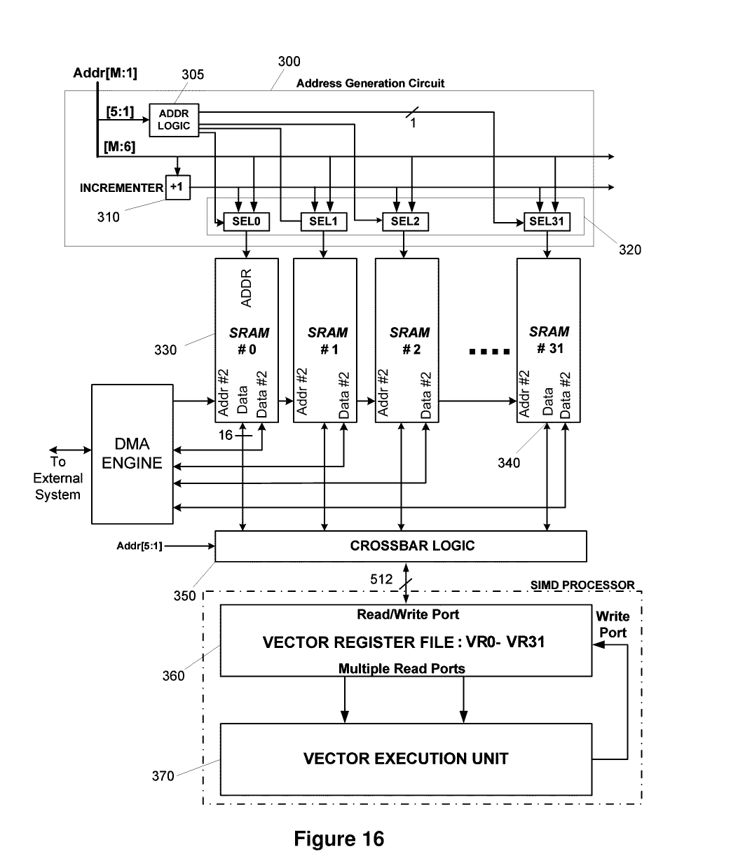

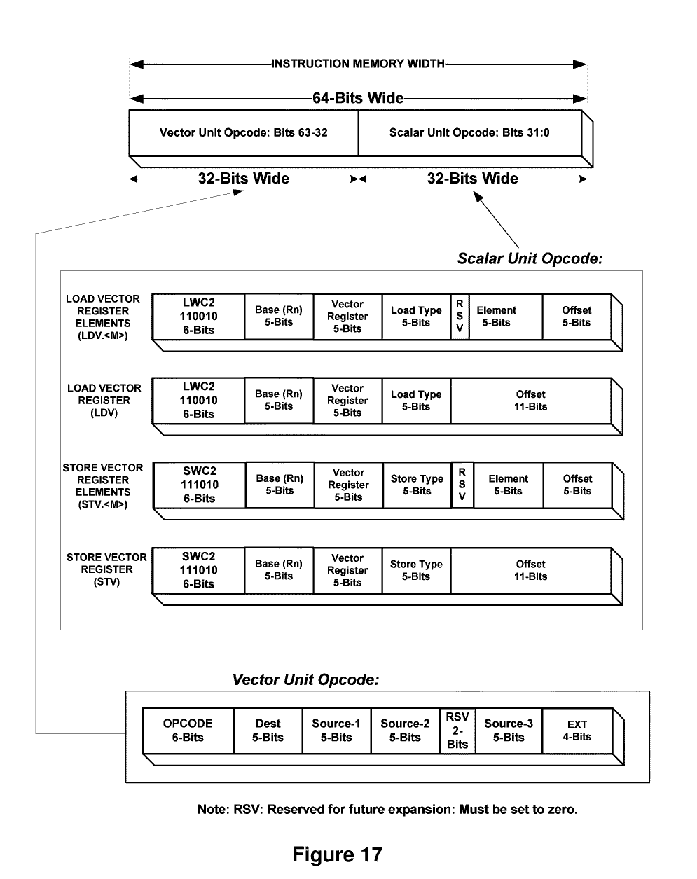

In a further embodiment of the present invention shown in FIG. 14, each of the partitioned data memory modules is dual ported where second data port (address and data) is connected to a DMA engine, so that data input/output and processing operations are parallelized and while RISC plus SIMD is performing vector load and processing operations, DMA engine takes out processed data and inputs new data to be processed concurrently using the second port of data modules.

1-38. (canceled)

39. An execution unit for transfer of a vector between a data memory and a vector register file in a single clock cycle and processing said vector, the execution unit comprising:
said vector register file including a plurality of vector registers with at least one data port; each of said plurality of vector registers storing n vector elements, n being an integer no less than 2;
said data memory comprised of at least n memory banks, each of said at least n memory banks having independent addressing and at least one data port, whereby said at least n memory banks are independently accessible in parallel and at the same time;
address generation means coupled to said at least n memory banks for accessing n consecutive elements of said vector in said data memory in accordance with an address pointing to first vector element of said vector; and
mapping means that is operably coupled between data ports of said at least n memory banks and said at least one data port of said vector register file for reordering vector elements during transfers of said vector between said vector register file and said data memory in accordance with said address.

40. The execution unit of claim 39, further including:
a RISC processor with a first instruction opcode;
vector processing means as a SIMD processor with a second instruction opcode, said SIMD processor processing vectors stored in said vector register file; and
said RISC processor is tightly coupled to said SIMD processor, wherein said RISC processor and said SIMD processor share said data memory and an instruction memory storing said first instruction opcode and said second instruction opcode for each entry, wherein said RISC processor performs all program flow control and vector transfer operations for said SIMD processor;
whereby one said RISC processor and one said SIMD processor instructions are executed during each cycle, and vector transfer and program flow control operations are performed in parallel with vector processing by said SIMD processor.

41. The execution unit of claim 40, further including:
a DMA engine for transferring a two-dimensional block portion of a video frame stored in an external system;
a second data port for said data memory that is coupled to said DMA engine for transferring data between said external system and said data memory;
whereby vector transfer and vector processing operations are performed in concurrence with data transfer operations by said DMA engine.

42. The execution unit of claim 39, wherein the number of said n vector elements is selected from the group consisting of {8, 16, 32, 64, 128, 256, 512, 1024}.

43. The execution unit of claim 39, wherein the number of said n vector elements N is an integer value between 2 and 1024, and each vector element width is selected from the group consisting of 8 bits, 16 bits, 32 bits, and 64 bits.

44. A method for loading a plurality of vector elements of a source vector from a data memory to a vector register file in a single step, the method comprising:
providing said data memory that is partitioned into a plurality of memory banks, each of said plurality of memory banks is independently addressable and at the same time, number of said plurality of memory banks is at least the same as the number of vector elements of said source vector;
providing said vector register file with the ability to store a plurality of vectors;
partitioning an input address pointing to first vector element of said source vector into two parts consisting of a bit-field of low-order address bits and a current line address consisting of remaining bit-field of high-order address bits, said bit-field of low-order address bits consists of K bits where 2^{K} addresses span width of said data memory;
calculating a next line address by adding value of one to said current line address;
selecting an address for each of said plurality of memory banks as one of said current line address or said next line address in accordance with position of respective memory bank and said bit-field of low-order address bits so that consecutive vector elements of said source vector are accessed;
addressing said plurality of memory banks with said selected respective addresses;
reordering data output of said plurality of memory banks in accordance with said bit-field of low-order address bits; and
storing said reordered data output into a selected vector of said vector register file.

45. The method of claim 44, wherein said next line address is selected for the first L memory banks starting with the first memory bank numbered as zero where L equals said bit-field of low-order address bits, and said current line address is selected for the rest of said plurality of memory banks.

46. The method of claim 44, wherein data output of said plurality of memory banks and elements of said source vector, numbered as a sequence of numbers from zero through N−1 (N=2^{K}), are mapped such that output of said memory bank numbered J (J=L+i modulo N) is mapped to element i of said source vector where L equals said bit-field of low-order address bits.

47. The method unit of claim 44, wherein the number of vector elements of said source vector is an integer value between 2 and 1024, and each vector element is a fixed-point integer or a floating-point number.

48. An execution unit for transferring a misaligned vector between a data memory and a vector register file in a single clock cycle and processing said misaligned vector, the execution unit comprising:
said data memory partitioned into even and odd memory banks with independent addressing containing respectively even and odd lines of data of said data memory, said data memory providing access to two consecutive lines in parallel;
means for address generation for said even and odd memory banks for accessing all consecutive vector elements of said misaligned vector;
a data selection circuit to select between vector element positions of data ports of said even and odd memory banks for accessing all consecutive elements of said misaligned vector; and
a crossbar circuit for reordering vector elements during transfers between said vector register file and said data memory.

49. The execution unit of claim 48, further including:
vector processing means as a SIMD processor, said SIMD processor processing vectors stored in said vector register file; and
a RISC processor using said data memory and performing program flow control and vector transfer operations for said SIMD processor;
whereby paired instructions for said RISC processor and said SIMD processor are executed during each cycle, and vector transfer operations are performed in parallel with vector processing by said SIMD processor.

50. The execution unit of claim 49, further including:
a DMA engine; and
a second data port for said data memory that is coupled to said DMA engine for transferring data between an external system and said data memory in parallel with vector processing and vector transfer operations.

51. The execution unit of claim 48, wherein the number vector elements for said misaligned vector is an integer value between 2 and 1024, and each vector element width is selected from the group consisting of 8 bits, 16 bits, 32 bits, and 64 bits.
